(19) United States
(12) Patent Application Publication
(10) Pub. No.: US 2026/0282191 A1
(43) Pub. Date: Sep. 17, 2026

(54) ELECTRONIC DEVICE FOR CONTROLLING LIGHT-EMITTING DIODES VIA SERIAL SIGNAL

(71) Applicant: SENAO NETWORKS, INC., Taoyuan (TW)

(72) Inventors: Chih Wei CHEN, Taoyuan (TW); Yang Chen, Taoyuan (TW)

(21) Appl. No.: 19/564,336

(22) Filed: Mar. 12, 2026

(30) Foreign Application Priority Data
Mar. 14, 2025 (TW) 114202584

(51) Int. Cl. H05B 45/44; H05B 45/20

(52) U.S. Cl. CPC H05B 45/44; H05B 45/20

(57) ABSTRACT

The electronic device includes a plurality of LEDs, a processor, and a controller. The plurality of LEDs are connected in series and in a sequence via a data line. The processor is configured to generate a first control signal, wherin the first control signal is a serial signal. The controller is electrically connected with the processor, and is electrically connected with the first of the plurality of LEDs in the sequence via the data line. The controller is configured to convert the first control signal into a second control signal, and provide the second control signal to the plurality of LEDs through the data line. The second control signal is a serial signal. The plurality of LEDs are illuminated according to the second control signal.

### CROSS-REFERENCE TO RELATED APPLICATIONS

This application claims priority to Taiwan Patent Application No. 114202584 filed on Mar. 14, 2025, which is hereby incorporated by reference in its entirety.

### BACKGROUND OF THE INVENTION

The present invention relates to an electronic device for controlling the lighting of light-emitting diodes (LEDs). More specifically, the present invention relates to an electronic device for controlling the lighting of LEDs by means of a serial signal.

LEDs are widely used for status indication and information display in various electronic devices. In conventional LED lighting control technologies, when multiple LEDs need to be controlled simultaneously, parallel signals are typically used to control the LEDs. This approach requires multiple signal traces corresponding to the number of LEDs, meaning that the more LEDs employed in the electronic device, the more wiring is needed for lighting control. Therefore, conventional techniques for controlling multiple LEDs often require additional space on the circuit board to accommodate routing, which not only reduces available layout space on the circuit board and increases circuit design complexity, but also restricts the types and/or the number of components that may be implemented thereon within board area constraints. If the number of LEDs and/or the area of the circuit board within the electronic device cannot be compromised, the overall size of the electronic device needs to be increased. This not only raises manufacturing costs, but may also reduce the usability, portability, and expandability of the electronic device.

Taking an Ethernet switch as an example, each port LED on the Ethernet switch usually relies on a trigger signal for actuation. However, most network switch chips output LED signals as serial signals (e.g., signals such as “LED_CLK” and “LED_DATA”). Therefore, circuit designs typically require the use of shift registers to convert the serial signals into parallel signals so as to achieve the lighting of all port LEDs. A disadvantage of this circuit design is that parallel signals require more routing space on the circuit board compared to serial signals. As a result, the lighting signals tend to occupy excessive routing space, thereby increasing the complexity of circuit design. Although the Ethernet switch is merely an example, similar situations are commonly encountered in many types of LED electronic devices.

In view of the above, how to improve the aforementioned technical shortcomings of conventional LED electronic devices is an urgent problem to be solved in the technical field of the present disclosure.

### SUMMARY OF THE INVENTION

In order to at least solve the above technical problems, the present disclosure provides an electronic device. The electronic device may comprise a plurality of LEDs, a processor, and a controller. The plurality of LEDs may be connected in series via a first data line such that data is transmitted sequentially from one LED to another. The processor may be configured to generate a first control signal. The first control signal may be a serial signal. The controller may be electrically connected to the processor and may be electrically connected, via the first data line, to a first LED of the plurality of LEDs in the sequence. The controller may be configured to convert the first control signal into a second control signal and to provide the second control signal to the plurality of LEDs via the first data line. The second control signal may be a serial signal, and the plurality of first LEDs may be illuminated according to the second control signal.

Optionally, the second control signal comprises a plurality of control signal segments corresponding to the plurality of first LEDs, and each of the plurality of first LEDs is illuminated according to a corresponding control signal segment.

Optionally, the plurality of control signal segments of the second control signal are arranged in sequence. Each first LED extracts a corresponding control signal segment from the second control signal, removes the corresponding control signal segment therefrom, and transmits a remaining portion of the second control signal to a subsequent LED in the sequence to control illumination thereof.

Optionally, the plurality of control signal segments in the second control signal are arranged in the sequence. Each first LED obtains a corresponding control signal segment from the second control signal according to the sequence, and then transmits the second control signal to a subsequent LED in the sequence to control illumination thereof.

Optionally, the plurality of first LEDs are RGB LEDs.

Optionally, each of the plurality of first LEDs comprises a red chip, a green chip, and a blue chip, and each of the plurality of control signal segments corresponding to the plurality of first LEDs has a size of 24 bits and comprises three sub-segments of 8 bits each, respectively controlling the red chip, the green chip, and the blue chip.

Optionally, the processor is a network switch chip.

Optionally, the controller is a microcontroller unit (MCU), a complex programmable logic device (CPLD), or a field-programmable gate array (FPGA).

Optionally, the plurality of first LEDs are used to indicate an operating status of the electronic device.

Optionally, the electronic device further comprises a plurality of second LEDs. Each of the plurality of second LEDs is electrically connected to the controller via a second data line. The processor is further configured to generate a third control signal for controlling the plurality of second LEDs. The third control signal is a serial signal and conforms to a format of the processor. In addition, the controller is further configured to convert the third control signal into a plurality of fourth control signals in parallel, the plurality of fourth control signals respectively corresponding to the plurality of second LEDs, and to respectively provide the plurality of fourth control signals to the plurality of second LEDs. The plurality of second LEDs are configured to be illuminated according to the plurality of fourth control signals.

As described above, the electronic device provided by the present disclosure adopts LEDs connected in a serial structure and uses the controller to convert a serial signal (i.e., the first control signal) output from the processor into a serial signal (i.e., the second control signal) readable by the serially connected LEDs. This can greatly reduce the number of circuit board traces required for controlling LED illumination, thereby reducing the space demand of the electronic device associated with the LEDs. This enables the overall size of the electronic device to be reduced and/or reserves more usable space for other circuit design purposes. Accordingly, the present disclosure indeed at least solves the technical problem in the prior art that requires a large number of traces and device space for controlling LED illumination.

The above description is not intended to limit the present disclosure but merely provides a general description of the technical problems that can be solved by the present disclosure, the technical means employed, and the technical effects that can be achieved, so as to enable those skilled in the art to preliminarily understand the present disclosure. According to the attached drawings and the contents described in the following embodiments, those skilled in the art can further understand various embodiments of the present disclosure.

### BRIEF DESCRIPTION OF DRAWINGS

FIG. 1 is a schematic diagram of an electronic device for controlling light-emitting diodes via a serial signal according to one or more embodiments of the present disclosure.

FIG. 2 is a schematic diagram illustrating the control of light-emitting diodes via a serial signal by the electronic device shown in FIG. 1.

FIG. 3 is a schematic diagram illustrating another way of controlling light-emitting diodes via a serial signal by the electronic device shown in FIG. 1.

FIG. 4 is a schematic diagram of another electronic device for controlling light-emitting diodes via a serial signal according to one or more embodiments of the present disclosure.

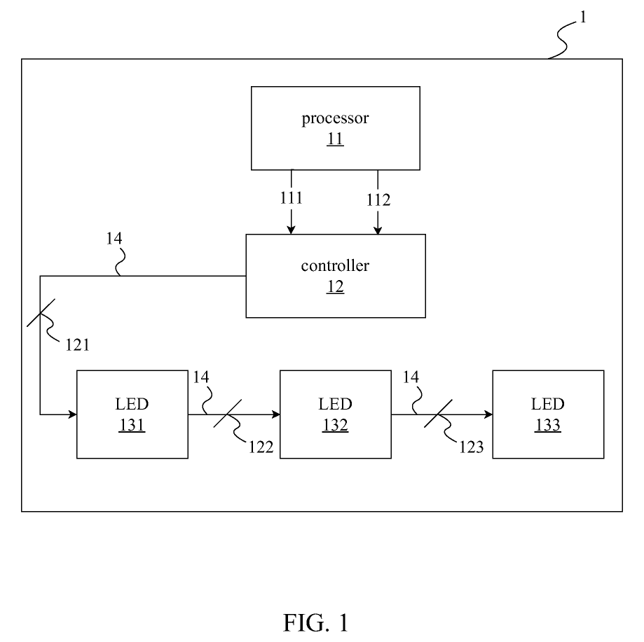

The contents shown in FIGS. 1-4 are merely provided as illustrative examples for illustrating embodiments of the present disclosure, and are not intended to limit the scope of the present disclosure.

### DETAILED DESCRIPTION OF THE INVENTION

The following embodiments are not intended to limit the claimed invention to a specific environment, application, structure, process, or situation. The contents shown in FIGS. 1-4 are merely provided as illustrative examples for explaining embodiments of the present disclosure, and are not intended to limit the scope of the present disclosure. In the attached drawings, elements unrelated to the claimed invention are omitted, and dimensions of and dimensional proportions among individual elements are merely exemplary, not intended to limit the claimed invention. Unless otherwise specified, the same element symbols in the following description may refer to the same elements.

Unless otherwise specified, the terms “a” or “an” as used herein are not intended to limit the number and should be construed as covering embodiments including a plurality of the same referents. The terms “comprising”, “including”, and “having” are used to indicate the presence of the features, integers, steps, operations, elements, components, and/or groups described thereafter, but do not preclude the presence or addition of one or more other features, integers, steps, operations, elements, components, and/or groups. The term “and/or” is used to denote any one or various combinations of one or more of the associated listed items. In addition, unless otherwise specified, the terms “first”, “second”, “third”, and the like used to describe the features, integers, steps, operations, elements, components, and/or groups are not intended to limit the order of the described objects, but merely to distinguish the described objects.

Various embodiments of the present disclosure relate to an electronic device for controlling the lighting of LEDs via a serial signal. Referring to FIG. 1, an electronic device 1 for controlling light-emitting diodes via a serial signal according to one or more embodiments of the present disclosure is illustrated. The electronic device 1 may generally be any type of electronic device equipped with LEDs, such as, but not limited to, an Ethernet switch, a gateway, a modem, a server, a desktop computer, a laptop computer, or a portable computing device. These LEDs may be used for purposes such as status indication or information display of the electronic device.

The electronic device 1 may comprise at least a processor 11, a controller 12, and a plurality of first LEDs, such as the three LEDs, LED 131, LED 132, and LED 133 shown in FIG. 1. The plurality of first LEDs may be serial LEDs, which may have a sequence and be connected in series via a first data line (i.e., data line 14). For example, in FIG. 1, LED 131, LED 132, and LED 133 may be connected in series via the data line 14. In some embodiments, the data line 14 may be a trace on a circuit board, while in other embodiments, the data line 14 may be a physical signal transmission line visible to the naked eye.

The processor 11 may be a programmable special-purpose integrated circuit having capabilities of computation, storage, and input/output operations, and may be configured to receive and process various encoded instructions to perform logical and arithmetic operations and output corresponding results. The processor 11 may be programmed to interpret various instructions and execute tasks or programs so as to perform various processing as described in the present disclosure. For example, the processor 11 may include a Central Processing Unit (CPU), a Digital Signal Processor (DSP), a microprocessor, and the like. More specifically, in certain embodiments, the electronic device 1 may be a network switch, and the processor 11 may be a network switch chip configured to perform various computations related to the network switch in an Ethernet architecture.

The controller 12 may be a microcomputer system that integrates components such as a Central Processing Unit (CPU), Random Access Memory (RAM), and input/output (I/O) interfaces on a single chip. Examples include, but are not limited to, a Microcontroller Unit (MCU), a Complex Programmable Logic Device (CPLD), and a Field Programmable Gate Array (FPGA). The processor 11 may be electrically connected to the controller 12, and electrical connection between the processor 11 and the controller 12 may be either direct (i.e., connected to each other without any intervening components) or indirect (i.e., connected to each other through other components).

The plurality of first LEDs included in the electronic device 1 (e.g., LED 131, LED 132, and LED 133 as shown in FIG. 1) may be serial LEDs, i.e., they can be driven by serial signals. In some embodiments, the plurality of first LEDs may be RGB LEDs, each comprising a red chip, a green chip, and a blue chip, thereby providing a richer spectrum of colored light.

As shown in FIG. 1, the data line 14 connects LED 131, LED 132, and LED 133 in series, and the controller 12 may be electrically connected, via the data line 14, to the first LEDs in the sequence among LED 131, LED 132, and LED 133—namely, LED 131.

The processor 11 may be used to generate a first control signal and provide it to the controller 12. The first control signal may be a serial signal, and more specifically may comprise a data signal 111 and a clock signal 112. The formats of these two types of signals may correspond to the hardware and/or firmware architecture of the processor 11. The data signal 111 is a digital signal composed of a sequence of 0s and 1s and may be used to represent various instructions for LED 131, LED 132, and LED 133, such as brightness, color, effects, and so on. The clock signal 112 is a periodic pulse signal and may be used to indicate when the LEDs should update their data and how fast the update should occur, to ensure that all LEDs are updated synchronously and avoid inconsistencies in display.

Subsequently, the controller 12 may be used to convert the data signal 111 and the clock signal 112 into another control signal 121. The format of the control signal 121 may correspond to the hardware and/or firmware architecture of the LED 131, LED 132, and LED 133 to be controlled—that is, it may adopt the driving signal format used by these specific LED models. For example, when the electronic device 1 intends to control LED 131, LED 132, and LED 133, the format of the data signal 111 and the clock signal 112 generated by the processor 11 may, in some implementations, be incompatible with direct reading by LED 131, LED 132, and LED 133. In such cases, the controller 12 serves to convert the data signal 111 and the clock signal 112 into a control signal 121 that can be read by LED 131, LED 132, and LED 133.

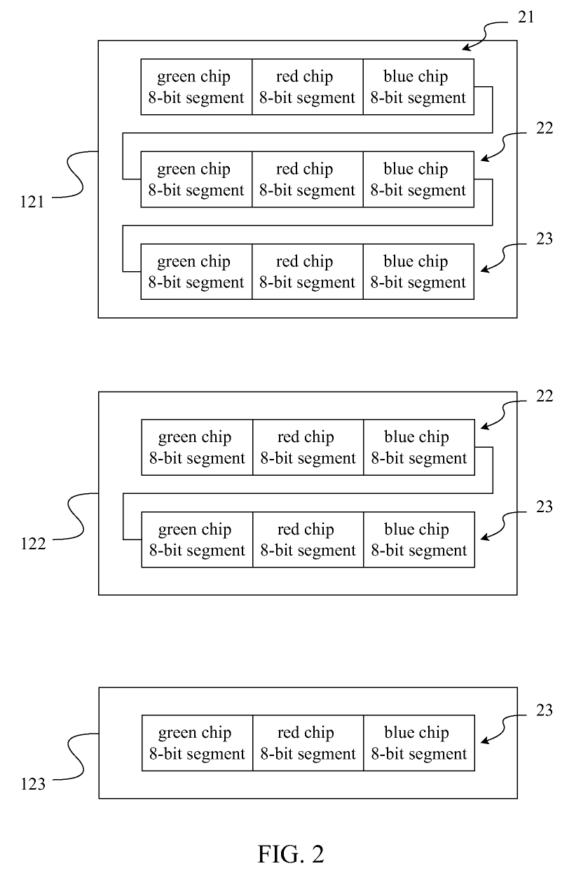

FIG. 2 illustrates the content of the control signal when the plurality of first LEDs shown in FIG. 1 are illuminated. Please refer to both FIG. 1 and FIG. 2. In some embodiments, the control signal 121 may comprise control signal segment 21, control signal segment 22, and control signal segment 23 corresponding respectively to LED 131, LED 132, and LED 133. The controller 12 may provide the control signal 121 to LED 131, LED 132, and LED 133 via the data line 14, and each of LED 131, LED 132, and LED 133 may be illuminated according to its corresponding control signal segment. In some embodiments, the control signal segments in control signal 121 are arranged in the sequence of the plurality of first LEDs. After receiving its respective control signal segment, each of LED 131, LED 132, and LED 133 may remove its own control signal segment, thereby preventing the subsequent LED in the sequence from reading the incorrect control signal segment and causing erroneous illumination.

More specifically, the controller 12 may provide the control signal 121 to the first of the three LEDs (namely LED 131) via the data line 14. LED 131 may extract the control signal segment 21 corresponding to itself from the control signal 121 for lighting, and then remove it. The remaining control signal segment 22 and control signal segment 23 are then treated as a new control signal 122 and provided to LED 132. Similarly, LED 132 may extract the control signal segment 22 corresponding to itself from control signal 122 for lighting, and then remove it. The remaining control signal segment 23 is then treated as control signal 123 and provided to LED 133. LED 133 may be illuminated according to the control signal segment 23. Through this approach, the electronic device 1 may configure the lighting mode for each of LED 131, LED 132, and LED 133 individually within a single signal sequence.

By adopting a serial configuration of LEDs (i.e., LED 131, LED 132, and LED 133) and converting the serial signal output from the processor 11 (i.e., the data signal 111 and the clock signal 112) into a serial signal readable by LED 131, LED 132, and LED 133 (i.e., the control signal 121) via the controller 12, the number of traces required on the circuit board for controlling the illumination of LED 131, LED 132, and LED 133 can be significantly reduced. This, in turn, reduces the space requirement of the electronic device 1 on the circuit board. In some embodiments, LED 131, LED 132, and LED 133 may further be configured to indicate the operating status of the electronic device 1, allowing a user to monitor the operating status of the electronic device 1.

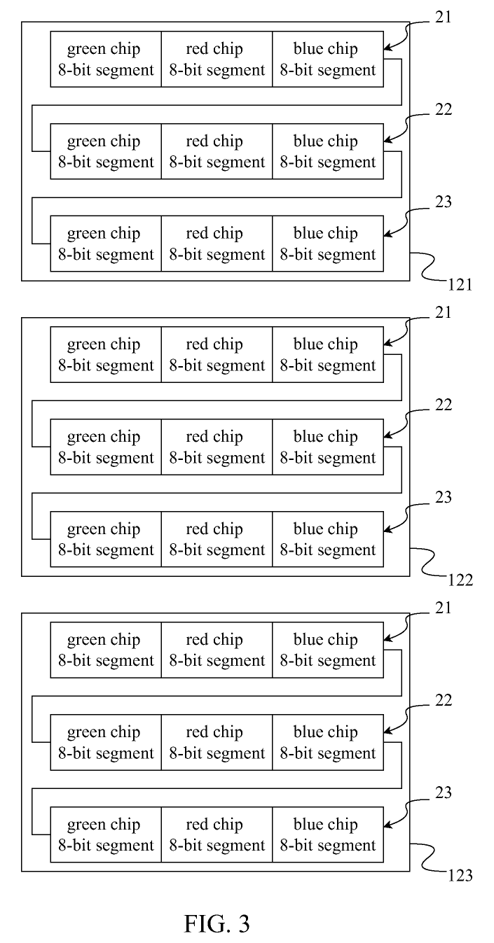

Please refer to both FIG. 1 and FIG. 3. FIG. 3 illustrates another embodiment of the control signal content for illuminating the plurality of first LEDs shown in FIG. 1. Compared with the embodiment shown in FIG. 1, although the plurality of first LEDs still extract their respective control signal segments, the extracted control signal segments are not removed from the control signal. More specifically, in some embodiments, LED 131, LED 132, and LED 133 may each include firmware corresponding to their position in the LED sequence, enabling each LED to determine which bit segment of the control signal 121 should be extracted. The controller 12 may provide the control signal 121 via the data line 14 to the first of the three LEDs (i.e., LED 131). LED 131 may extract the control signal segment 21 corresponding to itself from the control signal 121 to perform illumination, and directly transmit the control signal 122, which includes control signal segment 21, control signal segment 22, and control signal segment 23, to the subsequent LED 132. Similarly, LED 132 may extract the control signal segment 22 corresponding to itself from the control signal 122 to perform illumination, and directly transmit the control signal 123, which still includes control signal segment 21, control signal segment 22, and control signal segment 23, to the subsequent LED 133. LED 133 may extract the control signal segment 23 corresponding to itself from the control signal 123 and perform illumination accordingly.

As described above, in some embodiments, LED 131, LED 132, and LED 133 may be RGB LEDs, and each of LED 131, LED 132, and LED 133 may comprise a red chip, a green chip, and a blue chip. In addition, in some embodiments, the sizes of the control signal segment 21, control signal segment 22, and control signal segment 23 corresponding to LED 131, LED 132, and LED 133 may each have 24 bits, including three 8-bit sub-segments respectively corresponding to the green chip, red chip, and blue chip. These three 8-bit sub-segments may be used to respectively control the light emission of the red, green, and blue chips in an LED. By using 8-bit sub-segments to control the RGB LEDs, the emitted colors of the RGB LEDs may be more finely tuned, allowing them to emit a wider range of colors.

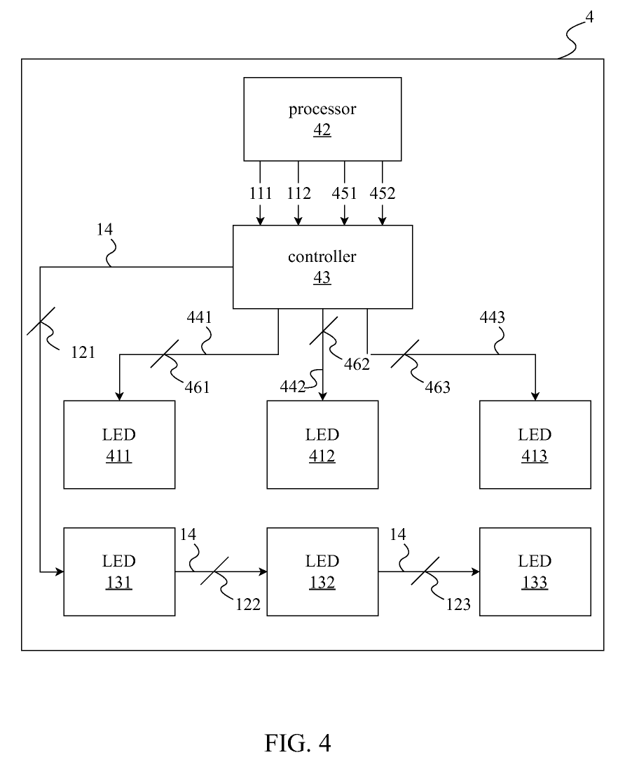

Referring to FIG. 4, FIG. 4 illustrates an electronic device 4 according to some embodiments of the present disclosure. The electronic device 4 is based on electronic device 1, with the addition of a plurality of second LEDs, namely LED 411, LED 412, and LED 413 shown in FIG. 4. More specifically, in some embodiments, the electronic device 4 may comprise a processor 42, a controller 43, a plurality of first LEDs (i.e., LED 131, LED 132, and LED 133 in FIG. 4), and the plurality of second LEDs. Similar to electronic device 1, the plurality of first LEDs may be serial LEDs arranged in sequence and connected in series via a data line 14. The data line 14 connects LED 131, LED 132, and LED 133 in series, and the controller 43 may be electrically connected to the first LED in the sequence (i.e., LED 131) through the data line 14. The processor 42 may also be electrically connected to the controller 43. The electrical connection between the processor 42 and the controller 43 may be either direct (connected without other components in between) or indirect (connected through other components). In some embodiment, the electronic device 4 may be a network switch, and the processor 42 may be a network switch chip.

In addition to the plurality of first LEDs, as shown in FIG. 4, each of LED 411, LED 412, and LED 413 comprised in the electronic device 4 may be electrically connected to the controller 43 via a respective second data line, namely data line 441, data line 442, and data line 443 in FIG. 4. Similarly, the plurality of second LEDs may also be used for purposes such as indicating the status of the electronic device 4 and presenting information.

In some embodiments, the plurality of second LEDs may be parallel-type LEDs. Accordingly, the processor 42 may further be used to generate a third control signal for controlling the plurality of second LEDs, and the third control signal may be a serial signal. The third control signal may similarly comprise a data signal 451 and a clock signal 452, and the formats of the data signal 451 and the clock signal 452 may correspond to the hardware and/or firmware architecture of the processor 42.

Subsequently, the controller 43 may further convert the data signal 451 and the clock signal 452 into a plurality of fourth control signals in parallel, such as the control signal 461, control signal 462, and control signal 463 shown in FIG. 4, which respectively correspond to LED 411, LED 412, and LED 413. The controller 43 may then respectively provide the control signal 461, control signal 462, and control signal 463 to LED 411, LED 412, and LED 413, thereby controlling the LED 411, LED 412, and LED 413 in a parallel manner. This embodiment enables the integration of serially driven LEDs and parallelly driven LEDs within a single electronic device, thereby simultaneously retaining the advantages of both types. The advantages of serially driven LEDs have been described above with reference to FIGS. 1-3, while the advantage of parallelly driven LEDs is that when one of the plurality of second LEDs fails, operation of the other LEDs will not be affected, thus improving fault tolerance with respect to partial LED failures.

In summary, the electronic device provided by the present disclosure adopts serially arranged LEDs and utilizes a controller to convert the serial signal output from the processor into a serial signal readable by the serial LEDs. This significantly reduces the number of circuit board traces required to control LED illumination, thereby also decreasing the space requirements of the electronic device associated with the LEDs. As a result, the size of the electronic device can be reduced and/or more space can be reserved for circuit designs for other purposes. Even in certain embodiments where additional parallel LEDs are included, the aforementioned advantages of the serial LED portion in the electronic device still remain. Accordingly, the present disclosure effectively addresses the technical issue in the prior art of requiring numerous traces and device space for LED illumination control.

The above embodiments are only examples for illustrating the embodiments of the present disclosure, and are not intended to limit the scope of the present disclosure. Any other embodiments produced by modifying, changing, adjusting, or integrating the above-mentioned embodiments shall all be included in the scope of the present disclosure as long as they can be contemplated by those of ordinary skill in the art. The scope of the present disclosure shall be governed by the claims.

1. An electronic device, comprising:
a plurality of first light-emitting diodes (LEDs) connected in series and in a sequence via a first data line;
a processor configured to generate a first control signal, wherein the first control signal is a serial signal; and
a controller electrically connected to the processor and electrically connected, via the first data line and according to the sequence, to a first LED of the plurality of first LEDs, the controller being configured to convert the first control signal into a second control signal and to provide the second control signal to the plurality of first LEDs via the first data line, wherein the second control signal is a serial signal; and
wherein the plurality of first LEDs are configured to be illuminated according to the second control signal.

2. The electronic device of claim 1, wherein:
the second control signal comprises a plurality of control signal segments corresponding to the plurality of first LEDs; and
each of the plurality of first LEDs is configured to be illuminated according to the corresponding control signal segment.

3. The electronic device of claim 2, wherein:
the plurality of control signal segments are arranged in the second control signal according to the sequence; and
each of the plurality of first LEDs extracts the corresponding control signal segment from the second control signal according to the sequence, removes the corresponding control signal segment from the second control signal, and transmits the second control signal to a subsequent LED in the sequence, so as to be illuminated.

4. The electronic device of claim 2, wherein:
the plurality of control signal segments are arranged in the second control signal according to the sequence; and
each of the plurality of first LEDs extracts the corresponding control signal segment from the second control signal according to the sequence, and transmits the second control signal to a subsequent LED in the sequence, so as to be illuminated.

5. The electronic device of claim 1, wherein the plurality of first LEDs are RGB LEDs.

6. The electronic device of claim 5, wherein:
each of the plurality of first LEDs comprises a red chip, a green chip, and a blue chip; and
each of the plurality of control signal segments corresponding to the plurality of first LEDs has a size of 24 bits and comprises three 8-bit sub-segments respectively controlling the red chip, the green chip, and the blue chip.

7. The electronic device of claim 1, wherein the processor is a network switch chip.

8. The electronic device of claim 1, wherein the controller is a microcontroller unit, a programmable logic device, or a field-programmable gate array.

9. The electronic device of claim 1, wherein the plurality of first LEDs are configured to indicate an operating status of the electronic device.

10. The electronic device of claim 1, further comprising a plurality of second LEDs, each of the plurality of second LEDs being electrically connected to the controller via a second data line, wherein:
the processor is further configured to generate a third control signal for controlling the plurality of second LEDs, the third control signal being a serial signal, and a format of the third control signal conforming to a format of the processor;
the controller is further configured to:
convert the third control signal into a plurality of fourth control signals in parallel, the plurality of fourth control signals corresponding to the plurality of second LEDs; and
provide the plurality of fourth control signals respectively to the plurality of second LEDs; and
the plurality of second LEDs are configured to be illuminated according to the plurality of fourth control signals.

11. The electronic device of claim 10, wherein the plurality of first LEDs are RGB LEDs.

12. The electronic device of claim 11, wherein:
each of the plurality of first LEDs comprises a red chip, a green chip, and a blue chip; and
each of the plurality of control signal segments corresponding to the plurality of first LEDs has a size of 24 bits and comprises three 8-bit sub-segments respectively controlling the red chip, the green chip, and the blue chip.

13. The electronic device of claim 10, wherein the processor is a network switch chip.

14. The electronic device of claim 10, wherein the controller is a microcontroller unit, a programmable logic device, or a field-programmable gate array.

15. The electronic device of claim 10, wherein the plurality of first LEDs and the plurality of second LEDs are configured to indicate an operating status of the electronic device.
